(19) United States
(12) Patent Application Publication
(10) Pub. No.: US 2010/0290973 A1
(43) Pub. Date: Nov. 18, 2010

(54) METHOD AND DEVICE FOR PROVIDING LIQUID SILICON

(75) Inventors: Alrbrecht Mozer, Burghausen (DE); Maximilian Stadler, Haiming (DE)

Correspondence Address: LERNER GREENBERG STEMER LLP, P O BOX 2480, HOLLYWOOD, FL, 33022-2480, US

(73) Assignee: CENTROTHERM SITEC GMBH, Blaubeuren (DE)

(21) Appl. No.: 12/778,423

(22) Filed: May 12, 2010

(30) Foreign Application Priority Data
May 12, 2009 (DE) DE102009021003.2

(51) Int. Cl. C01B 33/02; B01D 9/00

(52) U.S. Cl. 423/349; 422/245.1

(57) ABSTRACT

A method for providing liquid silicon comprising the method steps of filling (10) at least one crucible (50; 50a, 50b, 50c, 50d) with solid silicon (52), melting (12) the solid silicon (52) situated in the at least one crucible (50; 50a, 50b, 50c, 50d), and feeding (14; 24) liquid silicon (58) to the silicon (54) situated in the at least one crucible (50; 50a, 50b, 50c, 50d), and a device for carrying out the method.

The invention relates to a method for providing liquid silicon in accordance with the preamble of claim 1, and to a device for carrying out this method in accordance with the preamble of claim 12.

Silicon is of great importance in particular as a starting material for the electronics and photovoltaics industry. In most applications, metallurgical silicon cannot be used without further pretreatment. Generally, the metallurgical silicon is firstly purified and/or crystallized in a desired form. By way of example, polycrystalline silicon pieces, if necessary after purification of the silicon, are melted and recrystallized in the form of monocrystalline silicon ingots. The so-called Czochralski method, for example, can be used in this case. As an alternative, a recystallization in multicrystalline silicon blocks or else so-called silicon films or strips is carried out on an industrial scale.

In most cases, the recrystallization is effected from the liquid phase. For this purpose, silicon pieces are melted in heatable crucibles. The silicon pieces can be, for example, smashed silicon ingots, deposited from the gas phase according to the Siemens method, or metallurgical silicon. In principle, all forms of solid silicon can be used, in particular including silicon bodies produced by means of a fluidized bed method.

For melting purposes, the solid silicon is filled into crucibles. In this case, cavities arise, which are larger or smaller depending on the form of silicon used. This has the effect that after the solid silicon situated in a fully filled crucible has been melted, said crucible is then only partly filled. However, the filling level of the crucible often influences the quantity of silicon recrystallized in a method cycle. A filling level that is as high as possible is therefore striven for. For this purpose, the solid silicon is arranged in the crucibles in a heaped fashion, for example, such that a portion of the silicon pieces projects beyond the crucible. Even with this procedure, however, the crucible is usually only filled to the extent of 50 to 70% after the solid silicon has been melted. For this reason, before crystallization, further solid silicon is generally added to the silicon that has already been melted. This is often referred to as recharging.

The melting of this solid silicon subsequently fed takes up a certain time. An additional factor is that, besides a high filling level, in most cases a homogeneous silicon melt is required in order to ensure the required quality of the recrystallized silicon. In the case of crucibles currently used in industrial manufacturing, the subsequent feeding of solid silicon, the melting thereof and the homogenization of the silicon melt take up approximately twelve hours. Compared with a method in which subsequent feeding of solid silicon, that is to say recharging, is not required, this means a reduction of production capacity of approximately 20-25%, which is the cost for obtaining the desired high filling level of liquid silicon.

Against this background, the present invention is based on the object of providing a method which makes it possible to provide crucibles having a high filling level of liquid silicon in an expedient manner in respect of outlay.

This object is achieved by means of a method comprising the features of claim 1.

Furthermore, the invention is based on the object of providing a device for carrying out the method according to the invention.

This object is achieved by means of a device comprising the features of claim 12.

Dependent subclaims respectively relate to advantageous developments.

The basic concept of the method according to the invention consists in filling at least one crucible with solid silicon, melting the latter and feeding liquid silicon to the silicon situated in the at least one crucible.

The time expenditure for melting silicon that has been fed is obviated by the feeding of liquid silicon. Compared with feeding and melting solid silicon in accordance with the prior art, with the use of currently conventional crucibles, it is possible to achieve a time saving of up to 10 hours.

In principle, the feeding of the liquid silicon can be effected at any point in time at which the solid silicon situated in the at least one crucible has already been at least partly melted. Preferably, however, the feeding of liquid silicon is effected only after the solid silicon previously filled into the at least one crucible has been completely melted.

One configuration variant of the method according to the invention provides for the liquid silicon to be fed from a supply container. The latter is preferably thermally insulated from the surroundings and/or provided with a heating unit.

In one development of the invention, the supply container used is a supply crucible, in which solid silicon is melted. This molten silicon then constitutes the liquid silicon which can be fed to the at least one crucible. In principle, the supply crucible can be embodied structurally identically to the at least one crucible or can differ therefrom in terms of its structural configuration.

Advantageously, the solid silicon in the supply crucible and the solid silicon in the at least one crucible are melted with a temporal overlap. Consequently, a period of time exists in which both in the at least one crucible and in the supply crucible silicon is respectively present in a solid and liquid phase. In one advantageous configuration variant, the temporal overlap is chosen in such a way that, at the point in time of the complete liquefaction of the silicon situated in the at least one crucible, the silicon situated in the supply crucible is also completely liquefied.

In practice it has proved to be worthwhile to provide at least two crucibles which are initially filled with solid silicon. A number of four crucibles, in particular, has proved to be worthwhile. Advantageously, liquid silicon is fed to the at least two crucibles from the same supply container.

Advantageously, liquid silicon is fed to the at least two crucibles simultaneously. In this case, in principle, the silicon that is fed can be fed from different supply containers. It has proved to be particular advantageous, however, to feed liquid silicon to the at least two crucibles simultaneously from the same supply container.

As an alternative, liquid silicon can be fed to the at least two crucibles with a temporal offset. A serial filling of the at least two crucibles can be realized in this way. In this case, the silicon that is fed can once again be fed from different supply containers or the same supply container.

In one embodiment variant of the method according to the invention, the silicon situated in the at least one crucible is at least partly crystallized. The crystallization presupposes that the silicon situated in the at least one crucible is in a liquid state, that is to say has been melted beforehand.

In one configuration variant of the invention, liquid silicon is fed while silicon situated in the at least one crucible is crystallized. This can be the case, for example, if the crystallization is effected by the pulling of silicon films or silicon strips. Various technologies are known for this purpose. By way of example, pulling wires are pulled through the melt and between them a silicon skin forms, which subsequently solidifies. In another example, the crystallization can be effected in the form of silicon ingots, for example by means of a Czochralski method.

In an alternative embodiment variant of the method according to the invention, the crystallization is effected after the feeding of the liquid silicon. This has proved to be advantageous for example in the production of block-cast silicon. In this example, the crystallization is effected after the complete feeding of the liquid silicon, and thus after the substantial filling of the at least one crucible with liquid silicon and sufficient homogenization of the liquid silicon. This procedure can be employed particularly in the production of block-cast silicon, during the solidification of which a planar solid-liquid phase boundary is led through the silicon melt.

If the crystallization of the liquid silicon is effected in the at least one crucible or directly from the at least one crucible as in the case of film pulling, then the at least one crucible is preferably embodied as a crystallization crucible. In other words, a crucible is used which is provided with specific coatings such as silicon nitrate or graphite, for example, in order to reduce the risk of introduction of contamination. Depending on the crystallization method used, the crystallization crucibles can have other or additional specific properties.

A device for carrying out the method according to the invention provides at least one heatable crucible for melting solid silicon and at least one supply container for liquid silicon. In this case, liquid silicon can be fed from the supply container to the at least one crucible.

In one development of this device according to the invention, the supply container is embodied as a heatable supply crucible, in which solid silicon can be melted.

Preferably, the at least one heatable crucible is formed by at least two crucibles. The method can be carried out more efficiently in this way.

In one development of the device it is furthermore provided that liquid silicon can be fed from the supply container to the at least two crucibles simultaneously.

In one embodiment variant of the device according to the invention, the at least one crucible is embodied as a crystallization crucible. Crystallization crucibles are usually adapted to the respective crystallization process and provided with specific coatings, for example, as explained above. Furthermore, complicated heating units and associated open-loop and closed-loop control systems can be provided, which significantly increase the manufacturing outlay for a crystallization crucible by comparison with a conventional melting crucible. Nevertheless, the supply container can also be embodied as a crystallization crucible, even if no crystallization is effected in it. For cost reasons, however, the supply crucible is preferably configured more expediently in respect of outlay. By way of example, open-loop and closed-loop control systems for heating units can be embodied more expediently in respect of outlay. Depending on the desired degree of purity of the liquid silicon that is fed, a simplification of the coatings or the choice of more expedient materials for the embodiment of the supply crucible is also conceivable.

One advantageous embodiment variant of the invention provides for the supply container to be arranged at a higher level than the at least one crucible in such a way that liquid silicon can be fed from the supply container to the at least one crucible in a manner driven by gravitation. This makes it possible to dispense with complicated conveying units for liquid silicon.

Advantageously, the supply container is provided with at least one outlet and can be arranged relative to the at least one crucible in such a way that liquid silicon can be fed thereto via the at least one outlet. The specific configuration of the outlet can be chosen freely, in principle. By way of example, the outlet can be formed by a closable opening in the base wall of the supply container, in which case said opening would then be able to be arranged vertically above the at least one crucible.

A further configuration variant provides for the supply container to be connected to the at least one crucible via at least one feed line by means of which liquid silicon can be fed from the supply container to the at least one crucible. A feed line of this type can join an outlet of the supply container, for example. In this case, the feeding of the liquid silicon via the feed line can be effected by means of a conveying unit, for example a pump. Gravitation-driven feeding is obviously likewise conceivable.

The invention is explained in greater detail below with reference to figures. Insofar as is expedient, identically acting elements therein are provided with identical reference symbols. In the figures:

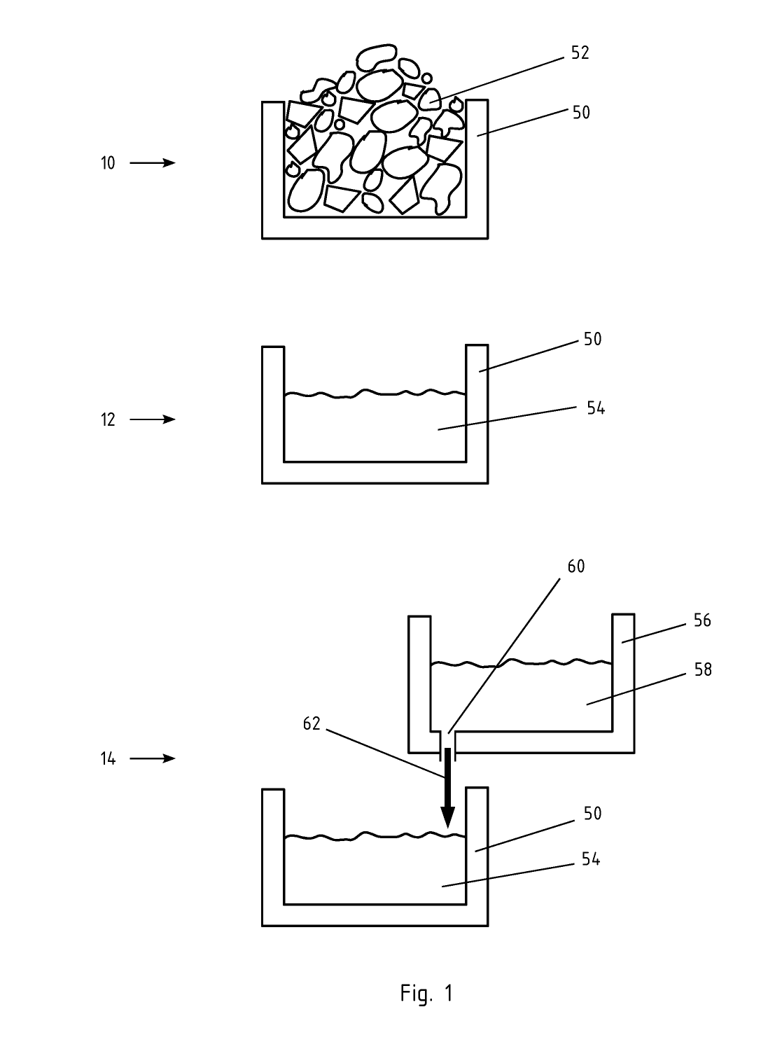

FIG. 1 shows a schematic illustration of a first exemplary embodiment of a method according to the invention and also a basic illustration of a first configuration variant of a device according to the invention.

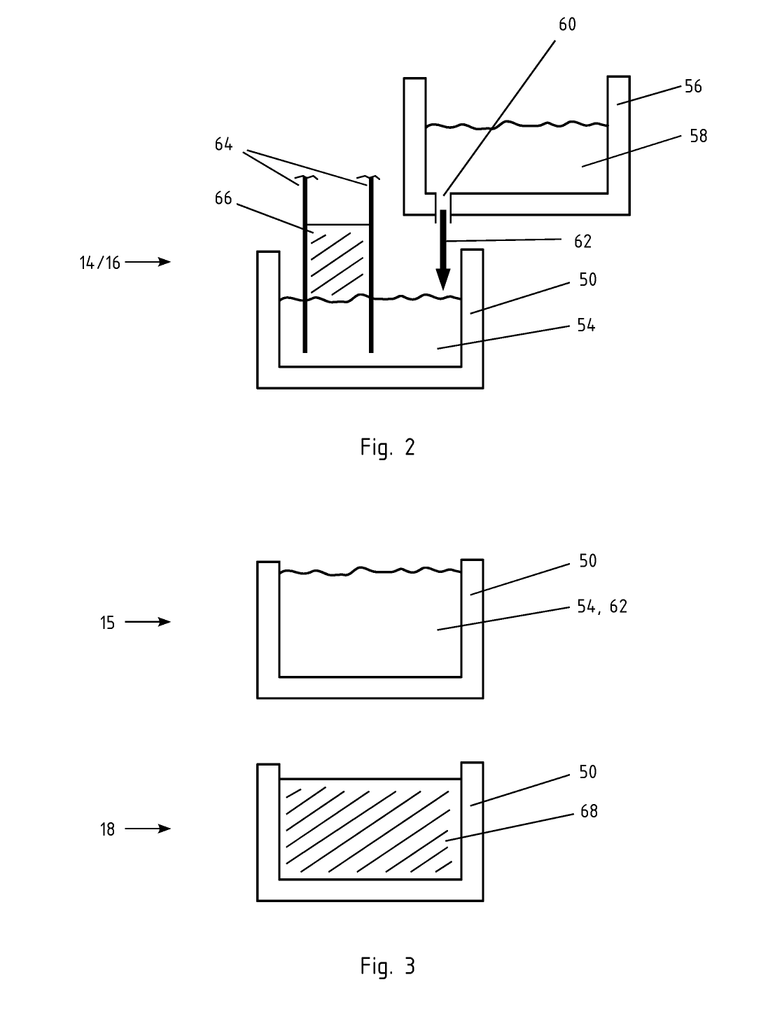

FIG. 2 shows a schematic illustration of an exemplary embodiment of the method according to the invention in which crystallization is effected with liquid silicon being fed at the same time.

FIG. 3 shows an exemplary embodiment of crystallization after the feeding of liquid silicon.

FIG. 4 shows a basic illustration of a method according to the invention in which liquid silicon is fed to a plurality of crucibles simultaneously, and a schematic illustration of a device according to the invention that is provided for this purpose.

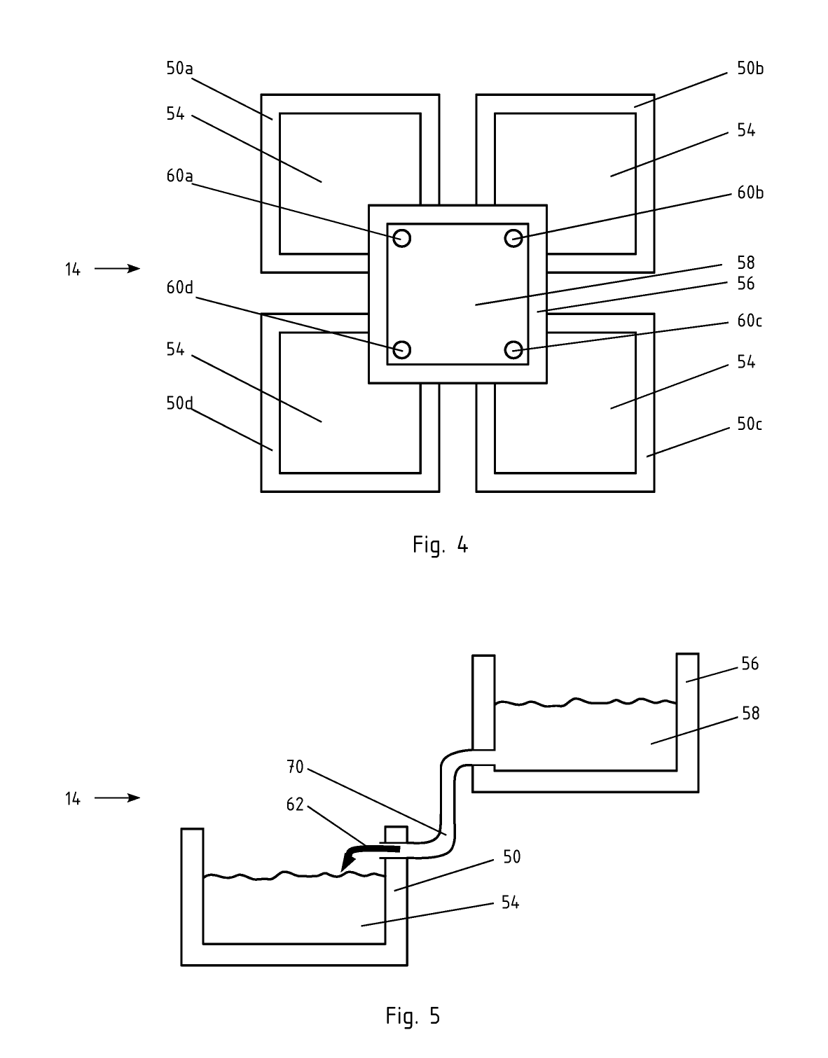

FIG. 5 shows a schematic illustration of a further exemplary embodiment of a device according to the invention.

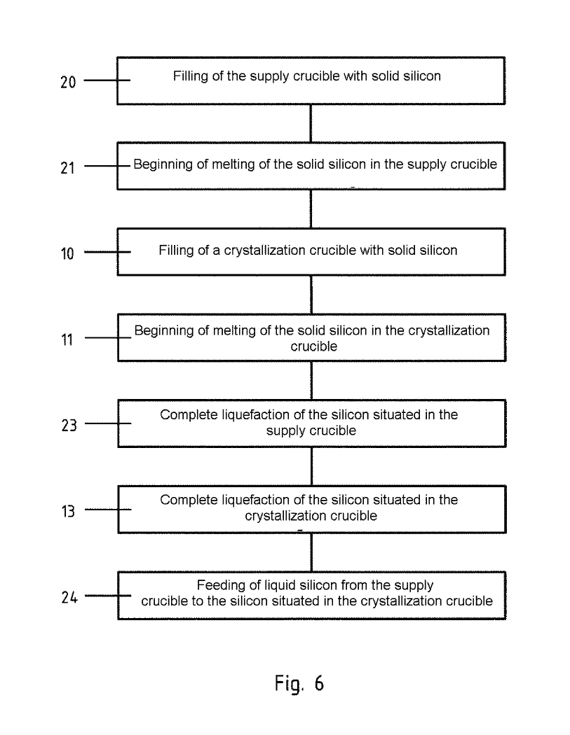

FIG. 6 shows a schematic illustration of a further exemplary embodiment of the method according to the invention.

FIG. 1 shows a schematic illustration of, inter alia, filling 10 of a crucible 50 with solid silicon 52. In this case, the solid silicon 52 is formed from silicon pieces having different sizes and different geometries. As shown in FIG. 1, the solid silicon 52 is arranged in a heaped manner in the crucible 50 in order to achieve a highest possible filling level in the crucible 50 after melting 12 of the solid silicon 52.

As illustrated in the middle illustration in FIG. 1, the crucible 50 is nevertheless only partly filled with molten silicon 54 after the melting 12 of the solid silicon 52. Consequently, liquid silicon 58 is subsequently fed 14 from a supply crucible 56. The device according to the invention as illustrated in the bottommost illustration in FIG. 1 provides, for this purpose, for the supply crucible 56 to be arranged at a higher level than the crucible 50 and to be provided with an outlet 60, which is arranged in the base wall of the supply crucible 56. The outlet 60 is embodied in closable fashion, the associated closure not being illustrated in FIG. 1, for the sake of better clarity. Furthermore, the outlet 60 is arranged above the crucible 50, more precisely above the opening in the crucible 50, such that, when the outlet 60 is opened, the silicon 62 that is fed passes into the crucible 50 owing to the effect of gravitation.

In principle, the supply crucible 56 can be arranged in a fixed fashion relative to the crucible 50. As an alternative, it is conceivable for the supply crucible 56 to be embodied in a movable fashion relative to the crucible 50 and to be able to be brought into the position illustrated in FIG. 1.

FIG. 2 illustrates in conjunction with FIG. 1 an exemplary embodiment of the method according to the invention in which, as indicated by the arrow 62, liquid silicon 62 is fed 14 while silicon 54 situated in the crucible 50 is crystallized 16. Instead of the simple feeding of liquid silicon as illustrated in FIG. 1, in the exemplary embodiment in FIG. 2 after the filling 10 of the crucible and the melting 12 of the solid silicon 52, the liquid silicon 58 is fed 14 from the supply crucible 56 (cf. arrow 62), while pulling wires 64 are pulled through the molten silicon 54 and fed silicon 62. A silicon skin is formed between said pulling wires 64 in the process, said silicon skin crystallizing as a silicon film 66.

In another configuration variant, the pulling wires 64 can be replaced by thin silicon ingots on which silicon situated in the crucible is crystallized in accordance with a Czochralski pulling method. In principle, the invention can be used in conjunction with all crystallization methods in which a seed crystal is used. However, the invention is not restricted to use in methods of this type, but rather can also be employed, in particular, in crystallization methods in which no seed crystal is used.

In a further configuration variant, there is the possibility that the crystallization is effected only after the feeding 14 of the liquid silicon 58. A corresponding exemplary embodiment is illustrated by FIG. 3 in conjunction with FIG. 1. FIG. 3 shows firstly the ending 15 of the feeding 14—illustrated in FIG. 1—of liquid silicon 58 from the supply crucible 56. At this point in time, the crucible 50 is virtually completely filled with molten silicon 54 and fed silicon 62. This is followed by the crystallization 18 of the liquid silicon 54 and of the fed silicon 62. The result of this crystallization 18 is shown by FIG. 3 in the lower illustration, in which a silicon block 68 crystallized in the crucible 50 can be discerned. The crystallization 18 can be effected by means of directional solidification, for example, preferably using a planar solid-liquid phase boundary.

FIG. 4 illustrates, in a plan view, firstly a preferred embodiment variant of the device according to the invention, and secondly an embodiment variant of the method according to the invention. Thus, in the illustration in FIG. 4, four crucibles 50a, 50b, 50c, 50d are provided, above which a supply crucible 56 is arranged. The supply crucible 56 is accordingly arranged at a higher level than the four crucibles 50a, 50b, 50c, 50d. The supply crucible 56 is provided with outlet openings 60a, 60b, 60c, 60d, which are once again arranged in the base wall of the supply crucible 56 and embodied in closable fashion. In this case, the outlets 60a, 60b, 60c, 60d are arranged above the different crucibles 50a, 50b, 50c, 50d, more precisely above the openings thereof, such that liquid silicon situated in the supply crucible 56 can be fed to the different crucibles 50a, 50b, 50c, 50d via the outlets 60a, 60b, 60c, 60d. This feeding 14 can once again be effected in a manner driven by gravitation by means of the device illustrated. The supply crucible 56 can be fixed in the position illustrated in FIG. 4 relative to the crucibles 50a, 50b, 50c, 50d or can be brought into the position illustrated, for example by means of a pivoting mechanism.

Assuming that the outlets 60a, 60b, 60c, 60d have been opened, FIG. 4 therefore also illustrates feeding 14 of the liquid silicon 58 from the supply crucible 56 to the silicon 54 situated in the crucibles 50a, 50b, 50c, 50d. In this case, liquid silicon 58 is evidently fed to the four crucibles 50a, 50b, 50c, 50d simultaneously from the same supply container 56.

FIG. 5 shows a further exemplary embodiment of a device according to the invention. In this device, the supply crucible 56 is once again arranged at a higher level than the one crucible 50. Consequently, gravitation-driven feeding of liquid silicon 58 from the supply crucible 56 to the molten silicon 54 situated in the crucible 50 is again possible. In the embodiment variant illustrated schematically in FIG. 5, the feeding is effected via a feed line 70, which connects the supply crucible 56 to the crucible 50. The arrow 62 represents the silicon fed via the feed line 70.

Contrary to the illustration in FIG. 5, in an alternative configuration variant, the supply crucible 56 can also be arranged at the same level as the crucible 50 or below the latter. The feeding 14 of liquid silicon 58 from the supply crucible 56 to the molten silicon 54 in the crucible 50 can nevertheless be effected via the feed line 70, but a conveying unit, for example a pump, has to be provided.

FIG. 6 schematically illustrates a configuration variant of the method according to the invention in which the solid silicon in the supply crucible 56 and the solid silicon 52 in the at least one crucible are melted with a temporal overlap. For this purpose, firstly the supply crucible is filled 20 with solid silicon. This is followed by the beginning of the melting 21 of said solid silicon in the supply crucible 56.

The at least one crucible, embodied as a crystallization crucible in the present exemplary embodiment, is subsequently filled 10 with solid silicon. This is followed by the beginning 11 of the melting of the solid silicon in the crystallization crucible.

Subsequently, a complete liquefaction 23 of the silicon situated in the supply crucible is achieved before a complete liquefaction 13 of the silicon situated in the crystallization crucible is achieved.

In this way, at the point in time of the complete liquefaction 13 of the silicon situated in the crystallization crucible, liquid silicon is present in the supply crucible, too, and can be fed 24 without any delay to the silicon situated in the crystallization crucible.

Depending on the requirements of the respective application, the developments illustrated in the exemplary embodiments in FIGS. 1 to 6 can obviously be combined with one another in a suitable manner. By way of example, in each of the exemplary embodiments illustrated, the crucible 50, 50a, 50b, 50c, 50d can be embodied as a crystallization crucible. Furthermore, feeding 14 of liquid silicon during the crystallization in accordance with the exemplary embodiment in FIG. 2 can also be provided in the embodiment variants in FIG. 4 or 5. Furthermore, it is possible, in particular, to carry out the method in accordance with the illustration in FIG. 6 using all of the devices according to the invention as illustrated in FIGS. 1 to 5.

### LIST OF REFERENCE SYMBOLS

10 Filling of the crucible
11 Beginning of melting of silicon in crystallization crucible
12 Melting of the solid silicon
13 Complete liquefaction of silicon in crystallization crucible
14 Feeding of liquid silicon
15 Ending of the feeding of liquid silicon
16 Crystallization of liquid silicon
18 Crystallization of liquid silicon
20 Filling of supply crucible
21 Beginning of melting of silicon in supply crucible
23 Complete liquefaction of silicon in supply crucible
24 Feeding of liquid silicon from supply crucible
50 Crucible
50a Crucible
50b Crucible
50c Crucible
50d Crucible
52 Solid silicon
54 Molten silicon
56 Supply crucible
58 Liquid silicon
60 Outlet
60a Outlet
60b Outlet
60c Outlet
60d Outlet
62 Fed silicon
64 Pulling wires
66 Crystallized silicon film
68 Crystallized silicon block
70 Feed line

1-19. (canceled)

20. A method for providing liquid silicon, which comprises the following method steps:
filling at least one crucible with solid silicon; and
melting the solid silicon situated in the at least one crucible; and
feeding liquid silicon to the silicon situated in the at least one crucible.

21. The method according to claim 20, which comprises at least partly melting the solid silicon situated in the at least one crucible before feeding in the liquid silicon.

22. The method according to claim 20, which comprises feeding the liquid silicon from a supply container.

23. The method according to claim 22, wherein the supply container is a supply crucible, in which solid silicon is melted.

24. The method according to claim 23, which comprises melting the solid silicon in the supply crucible and the solid silicon in the at least one crucible with a temporal overlap, and choosing the temporal overlap such that, at a point in time of a complete liquefaction of the silicon situated in the at least one crucible, the silicon situated in the supply crucible is also completely liquefied.

25. The method according to claim 20, wherein the at least one crucible is one of at least two crucibles.

26. The method according to claim 20, wherein the at least one crucible is one at least four crucibles.

27. The method according to claim 25, which comprises feeding liquid silicon to the at least two crucibles simultaneously.

28. The method according to claim 25, which comprises feeding the liquid silicon to the at least two crucibles simultaneously from the same supply container.

29. The method according to claim 20, wherein silicon disposed in the at least one crucible is at least partly crystallized.

30. The method according to claim 29, which comprises feeding liquid silicon while the silicon situated in the at least one crucible is being crystallized.

31. The method according to claim 29, which comprises causing the crystallization of the silicon after the feeding of the liquid silicon.

32. A device for carrying out the method according to claim 20, the device comprising:
at least one heatable crucible for melting solid silicon; and
at least one supply container for liquid silicon, wherein the liquid silicon may be fed from said at least one supply container to said at least one crucible.

33. The device according to claim 32, wherein said supply container is a heatable supply crucible configured for melting solid silicon.

34. The device according to claim 32, wherein said at least one crucible is one of at least two crucibles.

35. The device according to claim 32, wherein said at least one crucible is one of at least four crucibles.

36. The device according to claim 34, wherein said crucibles are connected to enable liquid silicon to be fed from said supply container to said at least two crucibles simultaneously.

37. The device according to claim 32, wherein said at least one crucible is a crystallization crucible.

38. The device according to claim 32, wherein said supply container is arranged at a higher level than said at least one crucible, to enable the liquid silicon to be fed from said supply container to said at least one crucible by gravitation.

39. The device according to claim 38, wherein said supply container is formed with at least one outlet and can be arranged relative to the at least one crucible in such a way that liquid silicon can be fed thereto via the at least one outlet.

40. The device according to claim 32, wherein said supply container is connected to said at least one crucible via at least one feed line and said feed line enables liquid silicon to be fed from said supply container to said at least one crucible.
